(19) United States
(12) Patent Application Publication
(10) Pub. No.: US 2026/0298386 A1
(43) Pub. Date: Oct. 1, 2026

(54) MECHANISM FOR SINGLE HAND OPERATION OF DUAL QUICK DISCONNECTS ON AN EXTERNAL DESKTOP RADIATOR

(71) Applicant: Lenovo (United States) Inc., Morrisville, NC (US)

(72) Inventors: Bryan Binda, Cary, NC (US); Alan L. Painter, Apex, NC (US); Marc R. Pamley, Durham, NC (US); Jean J. Xu, Cary, NC (US); Chunjian Ni, Cary, NC (US)

(21) Appl. No.: 19/096,368

(22) Filed: Mar. 31, 2025

(51) Int. Cl. F16L 37/56; F28F 9/02

(52) U.S. Cl. CPC F16L 37/56; F28F 9/0258

(57) ABSTRACT

An apparatus for single hand operation of dual quick disconnects on external desktop radiator is disclosed. The apparatus includes a guide that includes a base having a first set of holes respectively positioned in alignment with a first portion of each of a set of quick disconnects. The guide further includes elongated members that includes a distal end having a shaped alignment feature. The apparatus includes a decoupling bar that includes a second set of holes configured to interact with an outer ring of each of the first portion of the set of quick disconnects, the outer ring configured to decouple second portions of the set of quick disconnects from the first portions of the set of quick disconnects. The decoupling bar further includes a slot having a shape and position that corresponds to the shaped alignment feature.

### FIELD

The subject matter disclosed herein relates to operation of dual quick disconnects (“QDs”) and more particularly relates to mechanism for single hand operation of dual quick disconnects on external desktop radiator.

### BACKGROUND

Quick disconnects (“QDs”) are devices that allow for fast and easy connection of fluid lines. Quick disconnects enable rapid connection and disconnection of fluid lines without the need for tools, reducing downtime and improving efficiency. Typically, quick disconnect fittings are operated by hand. Some systems with dual quick disconnects require one hand for each to operate while another free hand is required to hold another device.

### BRIEF SUMMARY

An apparatus for single hand operation of dual quick disconnects on external desktop radiator is disclosed. The apparatus includes a guide that includes a base having a first set of holes respectively positioned in alignment with a first portion of each of a set of quick disconnects of tubing between a heat-generating device and a heat-receiving device. The guide further includes one or more elongated members extending from the base that includes a distal end having a shaped alignment feature. The apparatus includes a decoupling bar that includes a second set of holes, the second set of holes spaced at a same distance from each other as the first set of holes are spaced from each other. The second set of holes are configured to interact with an outer ring of each of the first portion of the set of quick disconnects, the outer ring configured to decouple second portions of the set of quick disconnects from the first portions of the set of quick disconnects. The decoupling bar further includes a slot having a shape and position that corresponds to the shaped alignment feature, such that when the shaped alignment feature is received in the slot, the first set of holes are aligned with the second set of holes.

Another apparatus for single hand operation of dual quick disconnects on external desktop radiator is disclosed. The apparatus includes a guide that includes a base having two first holes respectively positioned in alignment with first portion of each of two quick disconnects of tubing between a heat-generating device and a heat-receiving device. The guide further includes an elongated member extending from the base and a distal end having a shaped alignment feature. The apparatus includes a decoupling bar that includes two second holes, the two second holes the second set of holes spaced at a same distance from each other as the first set of holes are spaced from each other. The two second holes are configured to interact with outer rings of the first portions of the two quick disconnects, the outer rings configured to decouple second portions of the two quick disconnects from the first portions of the set of quick disconnects. The decoupling bar further includes a slot having a shape and position that corresponds to the shaped alignment feature, such that when the shaped alignment feature is received in the slot, the first two holes are aligned with the second two holes.

Another apparatus for single hand operation of dual quick disconnects on external desktop radiator is disclosed. The apparatus includes a guide that includes a base having a first set of holes respectively positioned in alignment with a first portion of each of a set of quick disconnects of tubing between a heat-generating device and a heat-receiving device. The guide is configured to be positioned over the tubing prior to the first portions of the set of quick disconnects being coupled onto the tubing of the heat-receiving device. The guide further includes one or more elongated members extending from the base and a distal end having a shaped alignment feature, a length of the one or more elongated members is sized to position the decoupling bar in a position to allow the second set of holes to be positioned against the corresponding outer ring of each of the first portion of the quick disconnects with a movement range to decouple the second portions of the set of quick disconnects from the first portions of the set of quick disconnects. The apparatus includes a decoupling bar that includes a second set of holes, the second set of holes spaced at a same distance from each other as the first set of holes are spaced from each other. The second set of holes are configured to interact with an outer ring of each of the first portion of the set of quick disconnects to simultaneously decouple second portions of the set of quick disconnects from the first portions of the set of quick disconnects. The decoupling bar further includes a slot having a shape and position that corresponds to the shaped alignment feature, such that when the shaped alignment feature is received in the slot, the first set of holes are aligned with the second set of holes.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a diagram illustrating a quick disconnect when the quick disconnect is decoupled, according to various embodiments;

FIG. 1B is a diagram illustrating the quick disconnect of FIG. 1A when the quick disconnect is coupled, according to various embodiments;

FIG. 2A is a front view of a guide, according to various embodiments;

FIG. 2B is a top view of the guide of FIG. 2A, according to various embodiments;

FIG. 2C is a side view of the guide of FIG. 2A, according to various embodiments;

FIG. 3A is a front view of a decoupling bar, according to various embodiments;

FIG. 3B is a top view of the decoupling bar of FIG. 3A, according to various embodiments;

FIG. 3C is a side view of the decoupling bar of FIG. 3A, according to various embodiments;

FIG. 4A is a perspective view of the invention before arrangement, according to various embodiments;

FIG. 4B is a perspective view of the invention after arrangement, according to various embodiments;

FIG. 5A is a front view of a decoupling bar with a collar, according to various embodiments;

FIG. 5B is a top view of the decoupling bar with a collar of FIG. 5A, according to various embodiments;

FIG. 5C is a cross-sectional view of a decoupling bar with a collar of FIG. 5A, according to various embodiments;

FIG. 6 is a diagram illustrating a quick disconnect attached to an external radiator and a base workstation, according to various embodiments;

FIG. 7A is a perspective view of actuating the decoupling bar, according to various embodiments;

FIG. 7B is a perspective view of dual quick disconnects beginning to decouple in response to actuating the decoupling bar, according to various embodiments; and

FIG. 7C is a perspective view of the dual quick disconnects decoupled in response to actuating the decoupling bar, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

The described features, structures, or characteristics of the embodiments may be combined in any suitable manner. In other instances, well-known structures, materials, or operations are not shown or described in detail to avoid obscuring aspects of an embodiment. The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

An apparatus for single hand operation of dual quick disconnects on external desktop radiator is disclosed. The apparatus includes a guide that includes a base having a first set of holes respectively positioned in alignment with a first portion of each of a set of quick disconnects of tubing between a heat-generating device and a heat-receiving device. The guide further includes one or more elongated members extending from the base and includes a distal end having a shaped alignment feature. The apparatus includes a decoupling bar that includes a second set of holes, the second set of holes spaced at a same distance from each other as the first set of holes are spaced from each other. The second set of holes are configured to interact with an outer ring of each of the first portion of the set of quick disconnects, the outer ring configured to decouple second portions of the set of quick disconnects from the first portions of the set of quick disconnects. The decoupling bar further includes a slot having a shape and position that corresponds to the shaped alignment feature, such that when the shaped alignment feature is received in the slot, the first set of holes are aligned with the second set of holes.

In some embodiments, the decoupling bar is configured to simultaneously decouple the second portions of the set of quick disconnects from the first portions of the set of quick disconnects. In some embodiments, a length of the one or more elongated members is sized to position the decoupling bar in a position to allow the second set of holes to be positioned against the corresponding outer ring of each of the first portion of the quick disconnects with a movement range to decouple the second portions of the set of quick disconnects from the first portions of the set of quick disconnects. In some embodiments, the guide is configured to be positioned over the tubing prior to the first portions of the set of quick disconnects being coupled onto the tubing of the heat-receiving device.

In some embodiments, the apparatus includes one elongated member positioned between the first set of holes. In some embodiments, the distal ends of the one or more elongated members is oblong with a long dimension perpendicular to a line bisecting all centers of the second set of holes. In some embodiments, the distal ends of the one or more elongated members is shaped to conform to the corresponding slot in the decoupling bar, and the corresponding slot is shaped to prevent rotation of the decoupling bar with respect to the guide.

In some embodiments, a diameter of each of the first set of holes is smaller than a diameter of the first portions of the set of quick disconnects, and a diameter of the second set of holes is smaller than a diameter of the second portions of the set of quick disconnects. In some embodiments, the base of the guide is incorporated in the heat-receiving device, and the heat-receiving device includes a coupling point to the one or more elongated members. In some embodiments, at least one distal end of the one or more elongated members includes a locking component configured to prevent the decoupling bar from sliding away from the guide. In some embodiments, each of the second set of holes includes a collar that extends towards the guide, each of the collars is configured to interact with the outer rings of the first portions of the set of quick disconnects.

Another apparatus for single hand operation of dual quick disconnects on external desktop radiator is disclosed. The apparatus includes a guide that includes a base having two first holes respectively positioned in alignment with first portion of each of two quick disconnects of tubing between a heat-generating device and a heat-receiving device. The guide further includes an elongated member extending from the base and a distal end having a shaped alignment feature. The apparatus includes a decoupling bar that includes two second holes, the two second holes the second set of holes spaced at a same distance from each other as the first set of holes are spaced from each other. The two second holes are configured to interact with outer rings of the first portions of the two quick disconnects, the outer rings configured to decouple second portions of the two quick disconnects from the first portions of the set of quick disconnects. The decoupling bar further includes a slot having a shape and position that corresponds to the shaped alignment feature, such that when the shaped alignment feature is received in the slot, the first two holes are aligned with the second two holes.

In some embodiments, the decoupling bar is configured to simultaneously decouple the second portions of the set of quick disconnects from the first portions of the set of quick disconnects. In some embodiments, the elongated member is positioned between the first set of holes. In some embodiments, the distal ends of the elongated member is oblong with a long dimension perpendicular to a line bisecting centers of the two second holes.

In some embodiments, the distal ends of the elongated members is shaped to conform to the slot in the decoupling bar, and the slot is shaped to prevent rotation of the decoupling bar with respect to the guide. In some embodiments, a diameter of each of the two first holes is smaller than a diameter of the first portions of the two quick disconnects, and a diameter of the two second holes is smaller than a diameter of the second portions of the two quick disconnects.

In some embodiments, the distal end of the elongated member includes a locking component configured to prevent the decoupling bar from sliding away from the guide. In some embodiments, each of the two second holes includes a collar that extends towards the guide, each of the collars is configured to interact with the outer rings of the first portions of the two quick disconnects.

Another apparatus for single hand operation of dual quick disconnects on external desktop radiator is disclosed. The apparatus includes a guide that includes a base having a first set of holes respectively positioned in alignment with a first portion of each of a set of quick disconnects of tubing between a heat-generating device and a heat-receiving device. The guide is configured to be positioned over the tubing prior to the first portions of the set of quick disconnects being coupled onto the tubing of the heat-receiving device. The guide further includes one or more elongated members extending from the base and a distal end having a shaped alignment feature, a length of the one or more elongated members is sized to position the decoupling bar in a position to allow the second set of holes to be positioned against the corresponding outer ring of each of the first portion of the quick disconnects with a movement range to decouple the second portions of the set of quick disconnects from the first portions of the set of quick disconnects. The apparatus includes a decoupling bar that includes a second set of holes, the second set of holes spaced at a same distance from each other as the first set of holes are spaced from each other. The second set of holes are configured to interact with an outer ring of each of the first portion of the set of quick disconnects to simultaneously decouple second portions of the set of quick disconnects from the first portions of the set of quick disconnects. The decoupling bar further includes a slot having a shape and position that corresponds to the shaped alignment feature, such that when the shaped alignment feature is received in the slot, the first set of holes are aligned with the second set of holes.

Quick disconnects (“QDs”) are devices that allow for fast and easy connection of fluid lines. Quick disconnects enable rapid connection and disconnection of fluid lines without the need for tool, reducing downtime and improving efficiency. Typically, quick disconnect fittings are operated by hand. Some systems with dual quick disconnects require one hand for each to operate while another free hand is required to hold another device. In some instances, a radiator assembly i.e., a heat-receiving device is coupled to a computing device i.e., a heat-generating device via two quick disconnects where the quick disconnects are required to be disconnected simultaneously to prevent damage to the cooling lines coupled by the quick disconnects. The quick disconnects must be actuated with the same force at the same time in order for them to decouple simultaneously. The disclosed invention is an apparatus that enables a user to simultaneously operate dual quick disconnects with single hand to simultaneously decouple the quick disconnects.

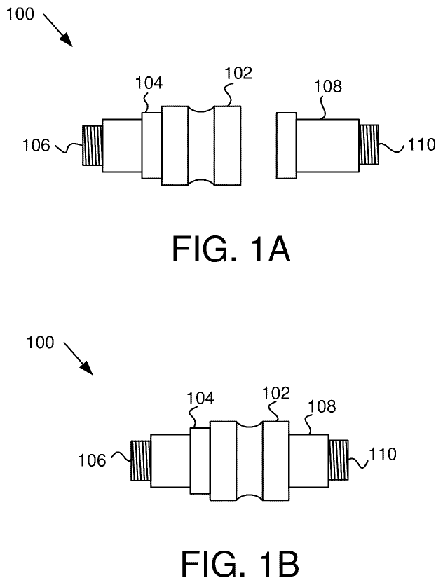

FIG. 1A is a diagram illustrating a quick disconnect (“QD”) 100 when the quick disconnect 100 is decoupled, according to various embodiments. The quick disconnect 100 includes a first portion 104 and a second portion 108, the first portion 104 includes an outer ring 102 and a first connecting portion 106, and the second portion 108 includes a second connecting portion 110.

In some embodiments, the first connecting portion 106 is configured to connect (e.g., via a first hose, tube, or the like not shown in FIG. 1A) to a heat-receiving device (e.g., a radiator assembly) and the second connecting portion 110 is configured to connect (e.g., via a second hose, tube, or the like not shown in FIG. 1A) to a heat-generating device (e.g., a base workstation). In some embodiments, each of the first connecting portion 106 and the second connecting portion 110 includes a connection mechanism, for example, threaded connection, flanged connection, welded connection, compression fitting, grooved couplings, etc. The connection mechanisms of the first connecting portion 106 and the second connecting portion 110 may be reciprocal or complementary and dimensioned to mate or couple detachably with one another. In some embodiments, the first connecting portion 106 and the second connecting portion 110 includes a mechanism that prevents fluid leakage, for example, using a gasket.

In some embodiments, the outer ring 102 is configured to be pushed rearwardly, i.e., towards the first connecting portion 106 when force is applied on the outer ring 102. When the outer ring 102 is pushed rearwardly, the second portion 108 of the quick disconnect 100 decouples from the first portion 104 of the quick disconnect 100, e.g., by use of a pulling force applied to the first portion 104 and/or the second portion 108.

FIG. 1B is a diagram illustrating a quick disconnect 100 when the quick disconnect 100 is coupled, according to various embodiments. In some embodiments, the second portion 108 may be coupled with the first portion 104 by using a mechanism such as a ball latching (also known as snap type), push-to-connect, a ball-lock, a camlock mechanism, or the like. In various embodiments, a set of quick disconnects e.g., 100a-100b (collectively or generally “100”) that are similar to the quick disconnect 100 shown in FIG. 1A and FIG. 1B are used for connecting the heat-receiving device and the heat-generating device.

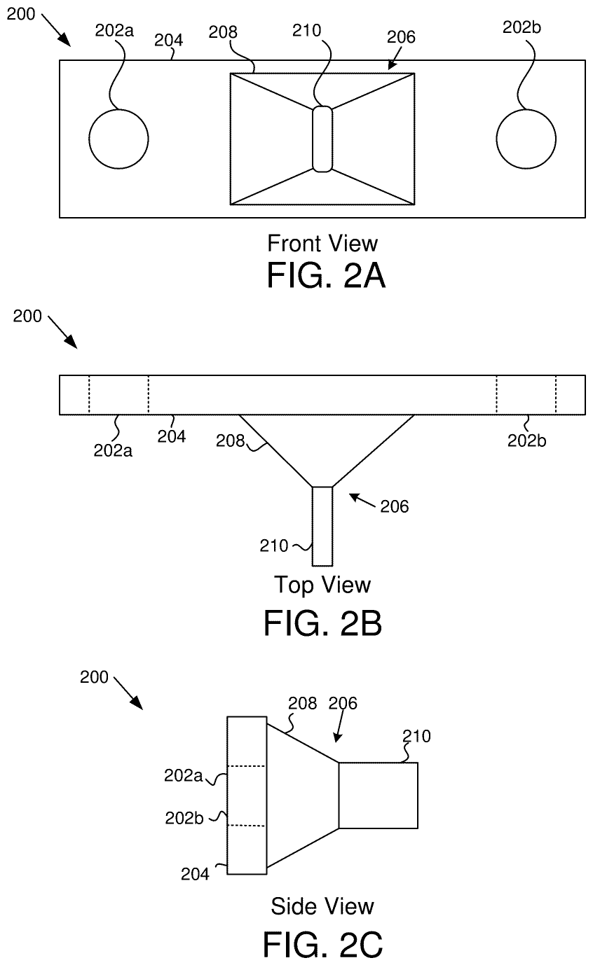

FIG. 2A is a front view of a guide 200, FIG. 2B is a top view of the guide 200, and FIG. 2C is a side view of the guide 200, according to various embodiments. The guide 200 includes a first set of holes 202a-202b (collectively or generically “202”), a base 204, and an elongated member 206. The elongated member 206 includes a proximal end 208 and a distal end 210. In some embodiments, the guide 200 includes more than two holes (e.g., 202a-202n). In some embodiments, the number of holes (e.g., 202a-202n) that the guide 200 includes may correspond to the number of quick disconnects (e.g., 100a-100n) being employed (e.g., connected between a heat-receiving device and a heat-generating device). In various embodiments, the first set of holes 202 is positioned to align with a first portion 104 of each of a set of quick disconnects 100 when coupled onto input and output tubing of a radiator assembly.

In some embodiments, the guide 200 is configured to be positioned over an input and output tubing of an external radiator prior to first portions 104 of the quick disconnects 100 being connected to the external radiator. In other embodiments, the guide 200 is configured to slide over the quick disconnects 100 to be positioned over the input and output tubing of the external radiator after the first portions 104 of the quick disconnects 100 are connected to the external radiator.

In some embodiments, the first set of holes 202 may be of different shapes such as circle, square, triangle, oval, etc. In some embodiments, the diameter of the first set of holes 202 may be smaller than the diameter of the first portions 104 of the quick disconnects 100 so that the guide 200 is configured to be positioned over an input and output tubing of an external radiator prior to first portions 104 of the quick disconnects 100 being connected to the external radiator, which helps to secure the guide 200 to the external radiator. In other embodiments, the diameter of the first set of holes 202 is larger than the diameter of the first portions 104 of the quick disconnects 100 when the guide 200 is configured to slide over the quick disconnects 100 to be positioned over the input and output tubing of the external radiator after the first portions 104 of the quick disconnects 100 are connected to the external radiator. In some embodiments, the base 204 is incorporated in the external radiator assembly. In some embodiments, the first set of holes 202 are configured as slots and are configured to slide down over the input and output tubing behind the first portions 104 of the quick disconnects 100.

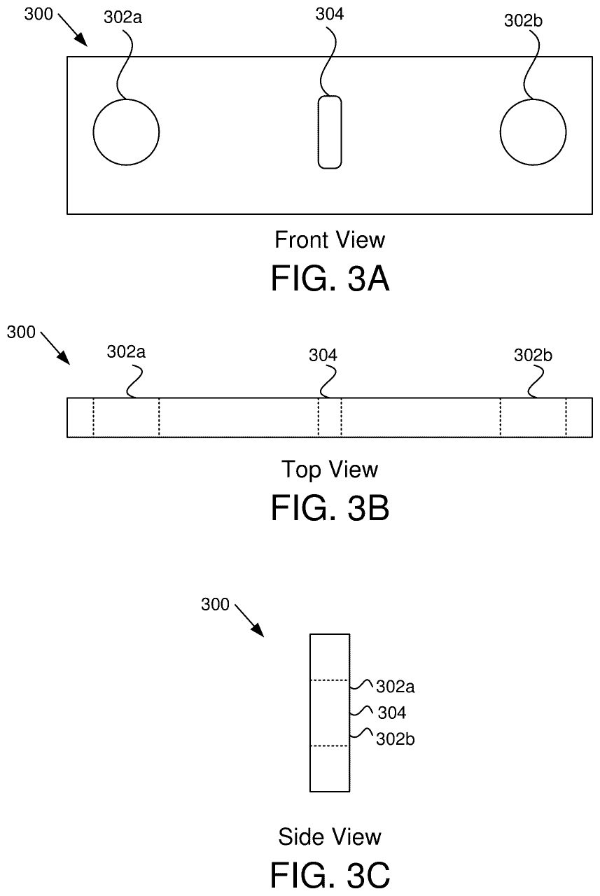

In some embodiments, the guide 200 includes an elongated member 206 that includes a proximal end 208 and a distal end 210. In some embodiments, the proximal end 208 is coupled to the base 204. In some embodiments, the distal end 210 has or includes a shaped alignment feature that is configured to slide through a corresponding slot in a decoupling bar 300 shown in FIGS. 3A-3B. The decoupling bar 300 is explained in greater detail in FIGS. 3A-3B. In some embodiments, the elongated member 206 is positioned between the first set of holes 202 of the guide, and may extend forwardly from a front surface (e.g., front planar surface) of a base 204 of the guide 200 in which the holes 202 are provided.

In some embodiments, the guide 200 includes multiple elongated members (e.g., 206a-206n) with corresponding proximal ends (e.g., 208a-208n) and distal ends (e.g., 210a-210n). In some examples, a guide 200 with two elongated members (e.g., 206a-206b) may have the two elongated members (e.g., 206a-206b) positioned at either edges of the guide 200. In some examples, a guide 200 with three elongated members (e.g., 206a-206c) may have one elongated member 206 positioned between the set of holes of the guide and two elongated members (e.g., 206b-206c) positioned at either edges of the guide 200.

In some embodiments, the distal end 210 of the elongated member 206 is oblong with a long dimension perpendicular to a line bisecting all centers of the first set of holes 202 of the guide 200. In other embodiments, the distal end 210 of the elongated member 206 is oblong with a short dimension perpendicular to a line bisecting all centers of the first set of holes 202 of the guide 200. In various embodiments, the oblong shape of the distal end 210 prevents the decoupling bar 300 from rotating with respect to the guide 200. In some embodiments, the distal end 210 of the elongated member 206 is shaped to conform to the corresponding slot in the decoupling bar 300. In some embodiments, where the guide 200 is incorporated in the radiator assembly, the radiator assembly includes a coupling point to the elongated member 206. In other embodiments, the distal end 210 is rectangular, has an X shape, has an oval shape, has a star shape, or other shape that prevents the decoupling bar 300 from rotating with respect to the guide 200.

In some embodiments, the distal end 210 includes a locking component (not shown) configured to prevent the decoupling bar 300 from sliding away from the guide 200. In some example, the locking component may rotate at the tip of the distal end 210 of the elongated member 206 by 90 degrees which acts as a stopper and stops the decoupling bar 300 at the tip of the distal end 210 of the elongated member 206. In other embodiments, the locking component is attached to the distal end 210 after the decoupling bar 300 is positioned over the distal end 210 of the elongated member 206.

The first hole 202a and the second holes 202b are indicated in FIG. 2B with dashed lines as they are not visible from the top view. FIG. 2B shows in greater detail the proximal end 208 coupled to the guide 200. In some embodiments, the proximal end 208 of the elongated member 206 is permanently attached to the base 204. In other embodiments, the elongated member 206 is attached to the guide 200 using fasteners. As shown in FIG. 2B, the width of the proximal end 208 of the elongated member 206 gradually increases from the distal end 210 to the guide 200. In some advantageous embodiments, increasing the width of the proximal end 208 which couples to the base 204 makes the attachment between the elongated member 206 and the guide 200 stronger and/or prevents the elongated member 206 from flexing or breaking.

The first hole 202a and the second hole 202b are indicated in FIG. 2C with dashed lines as they are not visible from the side view. FIG. 2C shows in greater detail the oblong shape of the distal end 210 of the elongated member 206. In some embodiments, the distal end 210 is shaped long and cubical or is a long prism which prevents a decoupling bar 300 from rotating with respect to the guide 200 when the distal end 210 is inserted into a slot of the decoupling bar 300. While the distal end 210 of the elongated member 206 is depicted larger than the proximal end 208, in other embodiments, the distal end 210 is the same size or is smaller than the proximal end 208.

FIG. 3A is a front view of a decoupling bar 300, FIG. 3B is a top view of the decoupling bar 300, and FIG. 3C is a side view of the decoupling bar 300, according to various embodiments. The decoupling bar 300 includes a second set of holes 302a-302b (collectively or generically “300”) and a slot 304. In various embodiments, the second set of holes 302 includes a same spacing as the first set of holes 202. In some embodiments, the second set of holes 302 are configured to interact with the outer rings 102 of the quick disconnects 100 to decouple the second portions 108 of the quick disconnects 100 from the first portions 104 of the quick disconnects 100. In some embodiments, the decoupling bar 300 is configured to simultaneously decouple the second portions 108 of the quick disconnects 100 from the first portions 104 of the quick disconnects 100. In some examples, force is applied by a user on one face of the decoupling bar 300 that faces towards the base workstation. This force causes the decoupling bar 300 to simultaneously apply force on all outer rings 102 of the quick disconnects 100 and decouple the quick disconnects 100.

In some embodiments, the number of the second set of holes (e.g., 302a-302n) of the decoupling bar 300 corresponds to the number of the first set of holes (e.g., 202a-202n) of the guide 200. In some embodiments, the number of the second set of holes (e.g., 302a-302n) corresponds to the number of quick disconnects (e.g., 100a-100n) being used. In some embodiments, the length of the elongated member 206 is sized to position the decoupling bar 300 in a position to allow the second set of holes 302 to be positioned against the corresponding outer ring 102 of each of the first portions 104 of the quick disconnects 100 with a movement range to decouple the second portions 108 of the set of quick disconnects 100 from the first portions 104 of the set of quick disconnects 100. In some embodiments, the distal end 210 of the elongated member 206 is oblong with a long dimension perpendicular to a line bisecting all centers of the second set of holes 302 of the decoupling bar 300. In other embodiments, the distal end 210 of the elongated member 206 is oblong with a short dimension perpendicular to a line bisecting all centers of the second set of holes 302 of the decoupling bar 300.

In some embodiments, the diameter of the second set of holes 302 is larger than the diameter of the second portions 108 of the set of quick disconnects 100. In some embodiments, the diameter of the second set of holes 302 is smaller than the diameter of the outer rings 102 allowing the second set of holes 302 to be positioned against the corresponding outer ring 102 of each of the first portion 104 of the set of quick disconnects 100. In other embodiments, the second set of holes 302 are slots allowing the decoupling bar 300 to be slid down over the second portions 108 of the quick disconnects 100. In other embodiments, the second set of holes 302 are round, rectangular, hexagonal, or other shape where at least a portion of the decoupling bar 300 is able to be positioned against the outer ring 102 of the quick disconnects 100.

The decoupling bar 300 includes a slot 304 that is configured or dimensioned to allow the distal end 210 of the elongated member 206 to slide though the slot 304. In some embodiments, the slot 304 is shaped to prevent rotation of the decoupling bar 300 with respect to the guide 200. In some embodiments, the slot 304 is shaped to match the shape of the distal end 210 of the elongated member 206. In some embodiments, the decoupling bar 300 includes multiple slots (e.g., 304a-304n). In some embodiments, the number of slots (e.g., 304a-304n) corresponds to the number of elongated members (e.g., 206a-206n). In some embodiments, the slot 304 is positioned to align the first set of holes 202 of the guide 200 with the second set of holes 302 of the decoupling bar 300 when the distal end 210 of the elongated member 206 slides through the slot 304.

The second set of holes 302 and the slot 304 are indicated in FIG. 3B with dashed lines as they are not visible from the top view. The second set of holes 302 and the slot 304 are indicated in FIG. 3C with dashed lines as they are not visible from the side view.

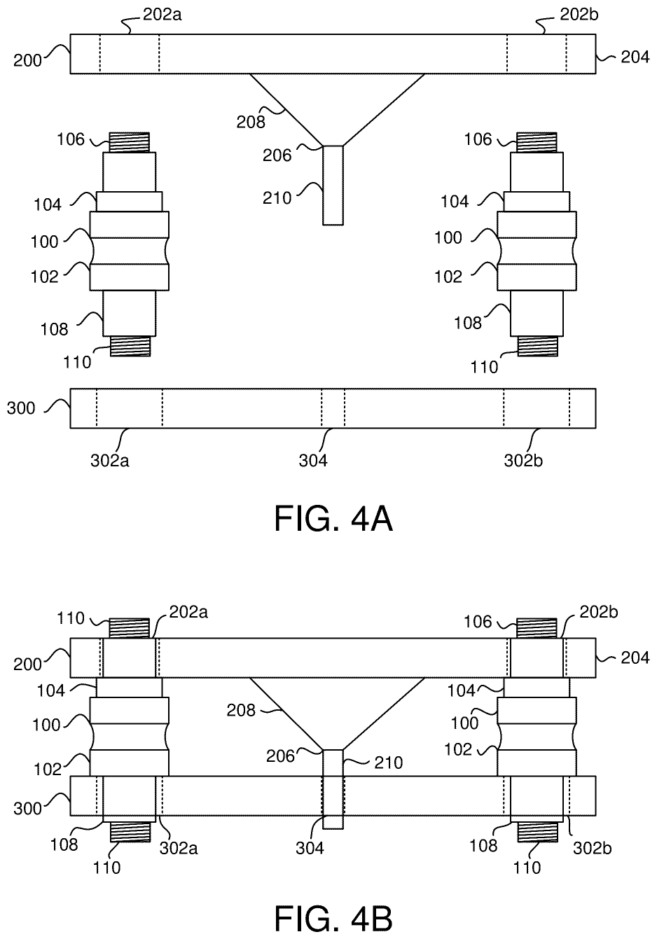

FIG. 4A is a perspective view of the invention before arrangement, according to various embodiments. FIG. 4A shows the guide 200 and the decoupling bar 300 from the top view. As shown in FIG. 4A, the quick disconnects 100 between the guide 200 and the decoupling bar 300, ready for installation.

FIG. 4B is a perspective view of the invention after arrangement, according to various embodiments. As shown in FIG. 4B, the distal end 210 of the elongated member 206 slides through the slot 304 of the decoupling bar 300 aligning the first set of holes 202 with the second set of holes 302. As shown in FIG. 4B, the decoupling bar 300 interacts with outer rings 102 of the set of quick disconnects 100. The second set of holes 302 is positioned against the corresponding outer ring 102 of each of the set of quick disconnects 100. FIG. 4B shows that the diameters of the first portions 104 of the quick disconnects 100 are larger than the diameters of the first set of holes 202 of the guide 200. This enables the first portions 104 of the quick disconnects 100 to hold the guide 200 in a fixed position when the first portions 104 of the quick disconnects 100 are connected to the external radiator assembly.

As shown in FIG. 4B, the length of the elongated member 206 is sized to position the decoupling bar 300 in a position to allow the second set of holes 302 to be positioned against the corresponding outer ring 102 of each of the first portion 104 of the quick disconnects 100 with a movement range to decouple the second portions 108 of the set of quick disconnects 100 from the first portions 104 of the set of quick disconnects 100.

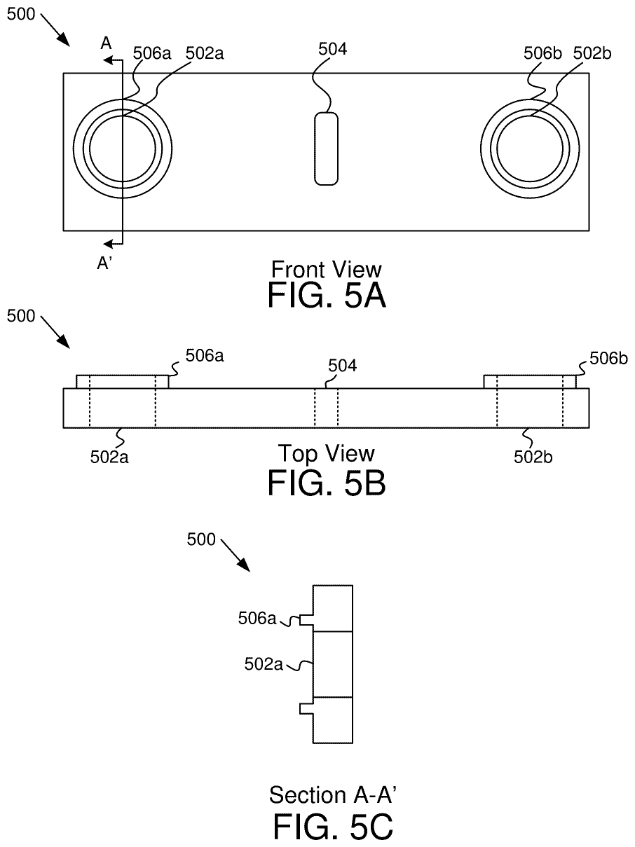

FIG. 5A is a front view, FIG. 5B is a top view, and FIG. 5C is a section view of another decoupling bar 500 with collars 506a-506b (collectively or generally “506”), according to various embodiments. In various embodiments, each of the second set of holes 502a-502b (collectively or generally “502”) of the decoupling bar 500 includes a collar 506 that extends outwardly from the decoupling bar, each of the collars 506 is configured to interact with the outer rings 102 of the first portions 104 of the set of quick disconnects 100. In some examples, the collars 506 surround the corresponding outer rings 102 of the quick disconnects 100 to hold the outer rings 102 in place and ready for actuation. In some advantageous embodiments, the collars 506 help the user to position each of the second set of holes 502 of the decoupling bar 500 onto the corresponding outer rings 102 of the quick disconnects 100. In some embodiments, the collars 506 may be shaped like a horseshoe or a U-shape.

FIG. 5B shows in greater detail the extension of the collars. In various embodiments, the collar 506 extends towards the guide 200 when the decoupling bar 500 operates to decouple the quick disconnects 100. As shown in FIG. 5C, the diameter of the second set of holes 502 is smaller than the diameter of the collars 506. The decoupling bar 500 shown in FIGS. 5A-5C includes a slot 504 that is similar to the slot 304 in FIGS. 3A-3C.

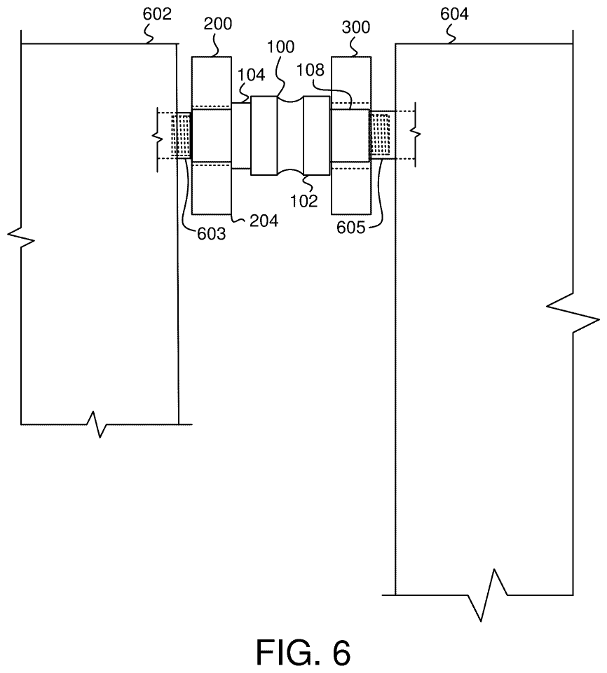

FIG. 6 is a diagram illustrating a quick disconnect 100 attached to an external radiator assembly 602 and a base workstation 604, according to various embodiments. While FIG. 6 shows a single quick disconnect 100 coupled to the external radiator assembly 602 and the base workstation 604, there may be multiple quick disconnects coupled to the external radiator assembly 602 and the base workstation 604. As seen in FIG. 6, the first portion 104 of the quick disconnect 100 is coupled to an external radiator and the second portion 108 of the quick disconnect 100 is coupled to a base workstation. It should be noted that the external radiator and the base workstation are merely examples. In other embodiments, first portions 104 of a set of quick disconnects 100 are coupled to a heat-receiving device 602 and second portions 108 of the set of quick disconnects 100 are coupled to a heat-generating device 604. In various embodiments, the heat-receiving device 602 is a device that supplies fluid to the heat-generating device 604 or vice versa.

In FIG. 6, a guide 200 may first be positioned by a user with one hand on an input and output tubing 603 of the heat-receiving device 602. In some embodiments, the first portions 104 of the set of quick disconnects 100 may then be coupled to the input and output tubing 603 of the heat-receiving device 602 with the second hand one by one. In various embodiments, the first portions 104 hold the guide in place after the first portions 104 are completely coupled to the input and output tubing 603. In some embodiments, the second portions 108 of the set of quick disconnects 100 are coupled, by a user to an input and output tubing 605 of the heat-generating device 604.

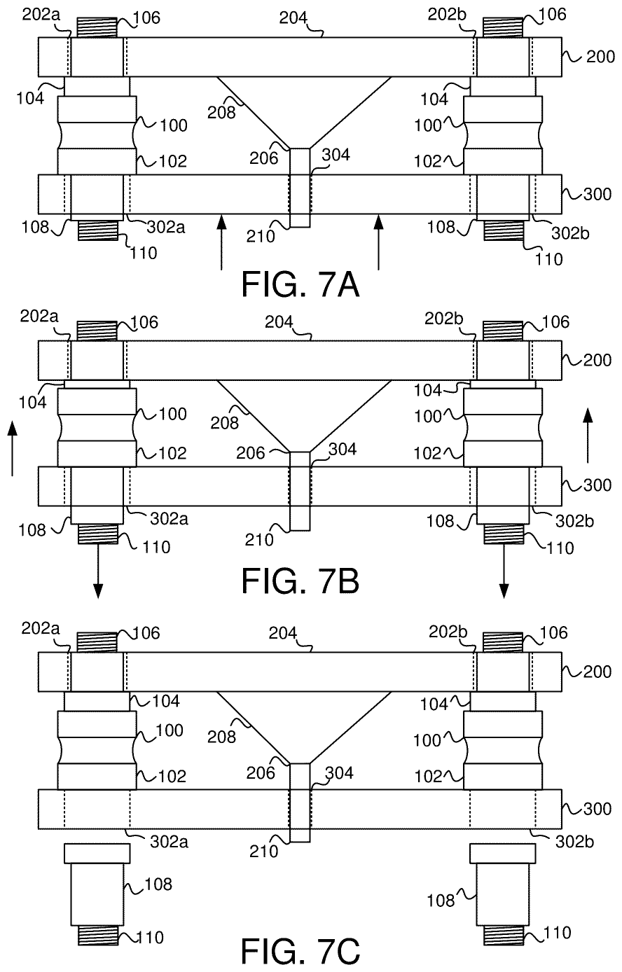

In some embodiments, a decoupling bar 300 may then be positioned against the outer rings 102 of the set of quick disconnects 100 by simply sliding a slot 304 of the decoupling bar 300 over a distal end 210 of the guide 200. In some embodiments, the first portions 104 of the set of quick disconnects 100 and the second portions 108 of the set of quick disconnects 100 are then coupled by moving the heat-receiving device 602 towards the heat-generating device 604. In various embodiments, to simultaneously decouple the set of quick disconnects 100 i.e., to simultaneously decouple the first portions 104 from the second portions 108 of the set of quick disconnects 100 the user may simply apply force on the face of the decoupling bar as shown in FIG. 7A.

FIG. 7A is a perspective view of actuating the decoupling bar 300, according to various embodiments. As shown in FIG. 7A, the arrow marks indicate a force being applied on the face of the decoupling bar 300 in the direction towards the guide 200. The force may be, for example, an external force applied by a user.

FIG. 7B is a perspective view of dual quick disconnects 100 beginning to decouple in response to actuating the decoupling bar 300, according to various embodiments. As shown in FIG. 7B the outer rings 102 are pushed towards the guide 200 in response to the force being applied on the decoupling bar 300. Simultaneously, the guide 200 and the decoupling bar 300 are pulled away from the second portions 108 of the quick disconnects 100. FIG. 7C is a perspective view of the dual quick disconnects 100 decoupled in response to actuating the decoupling bar 300, according to various embodiments. FIG. 7C shows the second portions 108 of the dual quick disconnects 100 decoupled from the first portions 104 of the dual quick disconnects in response to the outer rings 102 being pushed towards the guide 200.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a guide comprising a base having a first set of holes respectively positioned in alignment with a first portion of each of a set of quick disconnects of tubing between a heat-generating device and a heat-receiving device,
the guide further comprising one or more elongated members extending from the base and comprising a distal end having a shaped alignment feature, wherein the one or more elongated members remain rigidly coupled to the base and remain fixed with respect to the base; and
a decoupling bar comprising a second set of holes, the second set of holes spaced at a same distance from each other as the first set of holes are spaced from each other, wherein the second set of holes are configured to interact with an outer ring of each of the first portion of the set of quick disconnects, the outer ring configured to decouple second portions of the set of quick disconnects from the first portions of the set of quick disconnects, wherein in response to applying a force on the decoupling bar towards the guide, each of the second set of holes simultaneously applies equal force on the respective first portions of the set of quick disconnects,
the decoupling bar further comprising a slot having a shape and position that corresponds to the shaped alignment feature, such that when the shaped alignment feature is received in the slot, the first set of holes are aligned with the second set of holes, wherein the shape of the slot constrains the decoupling bar to movement in a direction towards and away from the guide.

2. The apparatus of claim 1, wherein the decoupling bar is configured to simultaneously decouple the second portions of the set of quick disconnects from the first portions of the set of quick disconnects.

3. The apparatus of claim 1, wherein a length of the one or more elongated members is sized to position the decoupling bar in a position to allow the second set of holes to be positioned against the corresponding outer ring of each of the first portion of the quick disconnects with a movement range to decouple the second portions of the set of quick disconnects from the first portions of the set of quick disconnects.

4. The apparatus of claim 1, wherein the guide is configured to be positioned over the tubing prior to the first portions of the set of quick disconnects being coupled onto the tubing of the heat-receiving device.

5. The apparatus of claim 1, comprising one elongated member positioned between the first set of holes.

6. The apparatus of claim 1, wherein the distal ends of the one or more elongated members is oblong with a long dimension perpendicular to a line bisecting all centers of the second set of holes.

7. The apparatus of claim 1, wherein the distal ends of the one or more elongated members is shaped to conform to the corresponding slot in the decoupling bar, and wherein the corresponding slot is shaped to prevent rotation of the decoupling bar with respect to the guide.

8. The apparatus of claim 1, wherein a diameter of each of the first set of holes is smaller than a diameter of the first portions of the set of quick disconnects, and wherein a diameter of the second set of holes is smaller than a diameter of the second portions of the set of quick disconnects.

9. The apparatus of claim 1, wherein the base of the guide is incorporated in the heat-receiving device, and wherein the heat-receiving device comprises a coupling point to the one or more elongated members.

10. The apparatus of claim 1, wherein at least one distal end of the one or more elongated members comprises a locking component configured to prevent the decoupling bar from sliding away from the guide.

11. The apparatus of claim 1, wherein each of the second set of holes comprises a collar that extends towards the guide, wherein each of the collars is configured to interact with the outer rings of the first portions of the set of quick disconnects.

12. An apparatus comprising:
a guide comprising a base having two first holes respectively positioned in alignment with first portion of each of two quick disconnects of tubing between a heat-generating device and a heat-receiving device;
the guide further comprising an elongated member extending from the base and comprising a distal end having a shaped alignment feature, wherein the elongated member remains rigidly coupled to the base and remain fixed with respect to the base; and
a decoupling bar comprising two second holes, the two second holes the second set of holes spaced at a same distance from each other as the first set of holes are spaced from each other, wherein the two second holes are configured to interact with outer rings of the first portions of the two quick disconnects, the outer rings configured to decouple second portions of the two quick disconnects from the first portions of the set of quick disconnects, wherein in response to applying a force on the decoupling bar towards the guide, each of the two second holes simultaneously applies equal force on the respective first portions of the set of quick disconnects,
the decoupling bar further comprising a slot having a shape and position that corresponds to the shaped alignment feature, such that when the shaped alignment feature is received in the slot, the first two holes are aligned with the second two holes, wherein the shape of the slot constrains the decoupling bar to movement in a direction towards and away from the guide.

13. The apparatus of claim 12, wherein the decoupling bar is configured to simultaneously decouple the second portions of the set of quick disconnects from the first portions of the set of quick disconnects.

14. The apparatus of claim 12, wherein the elongated member is positioned between the first set of holes.

15. The apparatus of claim 12, wherein the distal ends of the elongated member is oblong with a long dimension perpendicular to a line bisecting centers of the two second holes.

16. The apparatus of claim 12, wherein the distal ends of the elongated members is shaped to conform to the slot in the decoupling bar, and wherein the slot is shaped to prevent rotation of the decoupling bar with respect to the guide.

17. The apparatus of claim 12, wherein a diameter of each of the two first holes is smaller than a diameter of the first portions of the two quick disconnects, and wherein a diameter of the two second holes is smaller than a diameter of the second portions of the two quick disconnects.

18. The apparatus of claim 12, wherein the distal end of the elongated member comprises a locking component configured to prevent the decoupling bar from sliding away from the guide.

19. The apparatus of claim 12, wherein each of the two second holes comprises a collar that extends towards the guide, wherein each of the collars is configured to interact with the outer rings of the first portions of the two quick disconnects.

20. An apparatus comprising:
a guide comprising a base having a first set of holes respectively positioned in alignment with a first portion of each of a set of quick disconnects of tubing between a heat-generating device and a heat-receiving device, wherein the guide is configured to be positioned over the tubing prior to the first portions of the set of quick disconnects being coupled onto the tubing of the heat-receiving device,
the guide further comprising one or more elongated members extending from the base and comprising a distal end having a shaped alignment feature, wherein a length of the one or more elongated members is sized to position the decoupling bar in a position to allow the second set of holes to be positioned against the corresponding outer ring of each of the first portion of the quick disconnects with a movement range to decouple the second portions of the set of quick disconnects from the first portions of the set of quick disconnects, wherein the one or more elongated members remain rigidly coupled to the base and remain fixed with respect to the base; and
a decoupling bar comprising a second set of holes, the second set of holes spaced at a same distance from each other as the first set of holes are spaced from each other, wherein the second set of holes are configured to interact with an outer ring of each of the first portion of the set of quick disconnects to simultaneously decouple second portions of the set of quick disconnects from the first portions of the set of quick disconnects, wherein in response to applying a force on the decoupling bar towards the guide, each of the second set of holes simultaneously applies equal force on the respective first portions of the set of quick disconnects,
the decoupling bar further comprising a slot having a shape and position that corresponds to the shaped alignment feature, such that when the shaped alignment feature is received in the slot, the first set of holes are aligned with the second set of holes, wherein the shape of the slot constrains the decoupling bar to movement in a direction towards and away from the guide.
